(19) United States
(12) Patent Application Publication
(10) Pub. No.: US 2013/0107531 A1
(43) Pub. Date: May 2, 2013

(54) HEAT SINK FOR A SEMICONDUCTOR LAMP AND A SEMICONDUCTOR LAMP

(71) Applicants: Nicole Breidenassel, Bad Abbach (DE); Klaus Eckert, Herbrechtingen (DE); Guenter Hoetzl, Regensburg (DE); Markus Hofmann, Bad Abbach (DE); Fabian Reingruber, Muenchen (DE)

(72) Inventors: Nicole Breidenassel, Bad Abbach (DE); Klaus Eckert, Herbrechtingen (DE); Guenter Hoetzl, Regensburg (DE); Markus Hofmann, Bad Abbach (DE); Fabian Reingruber, Muenchen (DE)

(73) Assignee: OSRAM AG, Muenchen (DE)

(21) Appl. No.: 13/704,631

(22) PCT Filed: Jul. 8, 2011
(86) PCT No.: PCT/EP2011/061698

§ 371 Date: Dec. 17, 2012

(30) Foreign Application Priority Data
Jul. 13, 2010 (DE) 10 2010 031 293.2

(51) Int. Cl. F28F 21/08; F21V 29/00

(52) U.S. Cl. CPC F28F 21/08; F21V 29/22
USPC 362/249.02; 362/382; 165/185; 165/168; 165/109.1

(57) ABSTRACT

A heat sink may be constructed from at least one sheet-metal part and may include at least one flow structure, wherein the flow structure is configured to guide cooling air along an inner side of the heat sink, and wherein the flow structure is configured to direct the cooling air at least partially along a longitudinal axis of the heat sink on the inner side of the heat sink.

The invention relates to a heat sink for at least one semiconductor lamp. In addition, the invention relates to a semiconductor lamp with such a heat sink.

Owing to a high degree of waste heat from the light-emitting diodes (LEDs) for typical desired brightnesses and lifetimes, LED retrofit lamps require heat sinks with a cooling surface area of over 50% of the surface area of the lamp size, which is fixed by lamp standards.

It is known to use aluminum diecast heat sinks for LED retrofit lamps, but these heat sinks are relatively heavy and therefore make a significant contribution to markedly increased weight of the LED retrofit lamps in comparison with other lamp shapes. Heat sinks consisting of a thermally conductive polymer are also known, but these are markedly more expensive than aluminum diecast heat sinks given an equivalent heat dissipation performance. Sheet-metal bending heat sinks are also known which have a simple cylindrical form in order to achieve lower costs. Alternatively, “stacked fin” heat sinks are known which are more complex in terms of production engineering and are more costly.

The object of the present invention consists in eliminating at least one of the disadvantages of the prior art at least partially and in particular in providing a possibility for cooling a semiconductor lamp which provides the possibility of a smaller, more visible cooling surface area, a lower lamp weight and/or a lamp, in particular a retrofit lamp, with simpler production.

This object is achieved in accordance with the features of the independent claims. Preferred embodiments can be gleaned in particular from the dependent claims.

The object is achieved by a heat sink which is constructed from at least one sheet-metal part and has at least one flow structure, wherein the flow structure is configured to guide cooling air along an inner side of the heat sink, and wherein the flow structure is configured to direct the cooling air at least partially along a longitudinal axis of the heat sink on the inner side of the heat sink.

In this case, in the case of an irregularly shaped heat sink, the longitudinal axis is considered to be the axis of the greatest length extent, and in the case of a symmetrically shaped heat sink, it is considered to be the axis of symmetry, with the heat sink having the greatest length extent parallel to this axis of symmetry.

The flow structure can have in particular at least one air passage opening towards the inner side and/or at least one air-conducting region (for example an air baffle) arranged on the inner side. The at least one air-conducting region can have, for example, an air guide structure, for example air baffles, which extends at least partially vertically, i.e. parallel to the longitudinal axis. The air guide structure can also enlarge a heat dissipation area around which the cooling air can flow and thus improve cooling power.

The longitudinal axis may at the same time correspond to an axis of symmetry of the heat sink. The heat sink can be provided and configured in particular at one end (with respect to the longitudinal axis) for connection to at least one semiconductor light source and, at its other end, for connection to an electrical connection (for example base).

A flow of cooling air may in particular be at a maximum when the heat sink is aligned perpendicularly or has a perpendicular position or alignment. A perpendicular position or alignment of the heat sink can be understood to mean in particular a position or alignment in which a longitudinal axis of the heat sink is perpendicular. As an alternative or in addition, a perpendicular position can be understood to mean that the heat sink is aligned in such a way that its position corresponds to a position installed in the semiconductor lamp in which the at least one semiconductor light source and a base are arranged perpendicularly or vertically one above the other. In particular, a perpendicularly upwardly directed position or alignment can be understood to mean a position or alignment in which one end of the heat sink, which end adjoins the base, is below one end of the heat sink, which end adjoins the at least one semiconductor light source; analogously, a perpendicularly downwardly directed position or alignment can be understood to mean the reverse position.

The less perpendicular or the more horizontal the alignment of the heat sink, the lesser the flow of cooling air directed or deflected along the longitudinal axis may be.

The heat sink opens up the possibility of improved heat dissipation power being achieved in comparison with heat sinks provided for horizontal throughflow or in comparison with heat sinks in the form of simple sheet-metal cylinder sleeves, in particular in the case of a perpendicular alignment. Specifically, the flow structure, in particular the arrangement of the at least one air passage opening and/or the at least one air guide region, can make it possible for the heat sink to be subject to intensified flow also on its inner side, which increases the heat dissipation power. In addition, as a result of the deflection into the longitudinal direction, a relatively long air flow on the inner side can also be achieved in the case of a heat sink which is aligned at an angle (neither perpendicularly nor horizontally), which further improves the cooling power.

One configuration consists in that the heat sink is configured as a heat sink for a retrofit lamp. Thus, the associated lamp can be used as a replacement for a conventional lamp. When being used as a heat sink for a retrofit lamp, the heat sink is restricted, in terms of its outer contour, at least approximately to the corresponding outer contour of a conventional lamp. As a result, a heat sink is required which provides the possibility of a high degree of heat dissipation power over a small space, which is provided by the present invention.

The retrofit lamp can in particular be an incandescent lamp retrofit lamp (for replacing a conventional incandescent lamp). Alternatively, the retrofit lamp can also be a halogen lamp retrofit lamp, for example.

A further configuration consists in that the heat sink is produced from a plurality of sheet-metal parts. In this case, it is preferred for the heat sink to be produced from no more than five sheet-metal parts, in particular from no more than three sheet-metal parts. This results in a weight saving in comparison with an aluminum diecasting and reduced production complexity in comparison with the thermally conductive polymer. In addition, a simple and inexpensive assembly of the heat sink is made possible.

A particularly advantageous configuration for inexpensive production and a long life consists in that the heat sink includes (precisely) one sheet-metal part, i.e. is in the form of an integral sheet-metal part.

The sheet metal can be in particular sheet steel, copper and/or aluminum. However, the sheet metal may also contain any other suitable plastically deformable material with good thermal conductivity. Such a material can have in particular a thermal conductivity A of at least 15 W/(m·K), in particular of more than 50 W/(m·K), in particular of more than 100 W/(m·K). Correspondingly, the invention can therefore also be implemented with a material which has the essential properties for shaping of sheet metal, i.e. easy plastic deformability with correspondingly large expansion and high thermal conductivity, without necessarily being a metal material.

The at least one sheet-metal part can in particular be configured as a sheet-metal bending part, whose shape has been formed in particular at least partially by a sheet-metal bending operation, a deep-drawing operation and/or a stamping operation. This enables particularly simple production.

A further configuration consists in that the heat sink or flow structure has or includes a first group of air passage openings with at least one first air passage opening and a second group of air passage openings with at least one second air passage opening, wherein, given a perpendicular position of the heat sink, the at least one air passage opening in one group acts as an air inlet opening and the at least one air passage opening in the other group acts as an air outlet opening.

In the event of the perpendicular alignment being changed from a downwardly pointing position to an upwardly pointing position, or vice versa, at least one of the air passage openings can change from its function as an air inlet opening to an air outlet opening, or vice versa. At least one of the air passage openings can also continue to be an air inlet opening or an air outlet opening.

A development consists in that the heat sink or the flow structure has a first group of air passage openings and a second group of air passage openings, wherein, given a perpendicular position of the heat sink, the at least one air passage opening in the first group acts as an air inlet opening and the at least one air passage opening in the second group acts as an air outlet opening (the reverse is true in the case of a change in the alignment).

Advantageously, the plurality of air passage openings in one group, in particular all of the air passage openings in one group, act in the same way given a perpendicular position of the heat sink, i.e. either as air inlet openings or as air outlet openings (with the function preferably changing in the event of a change in the alignment). Thus, in particular a uniform and/or defined flow distribution can be achieved.

Another development consists in that the first group and the second group of air passage openings are arranged separately from one another along a longitudinal axis of the heat sink. Thus, a physical separation of the air passage openings in the different groups is achieved, as a result of which increased vertical air flow is produced on the inner side of the heat sink. The air passage openings along different sections of the longitudinal axis can be distributed between the groups as desired. The air passage openings in one group can be arranged at a contiguous section of the longitudinal axis or can be split into two or more subsets (which are arranged at different sections of the longitudinal axis) by air passage openings in the other group.

In addition, a configuration consists in that each group has a plurality of air passage openings which are arranged rotationally symmetrically with respect to a longitudinal axis of the heat sink. This results in an air throughflow which is uniform irrespective of a rotational position of the semiconductor lamp with respect to the longitudinal axis or the lamp holder accommodating the lamp.

In addition, a configuration consists in that at least one air passage opening, in particular in one group, is arranged in a rest region for at least one semiconductor light source of the semiconductor lamp. This results in the advantage that air can flow out of a light source space arching over the at least one semiconductor light source directly to the heat sink (in particular in the case of a position directed perpendicularly downwards) or cooling air can flow directly into the light source space (in particular in the case of a position directed perpendicularly upwards). Thus, good heat dissipation of the rest region heated by the at least one semiconductor light source onto the heat sink can also be achieved. As a result, the semiconductor light sources can be cooled particularly effectively. The at least one air passage opening can include in particular a plurality of air passage openings, in particular air passage openings arranged in the form of a ring.

A development consists in that an at least partially vertically extending air guide structure is provided between at least one air passage opening in the first group and at least one coupled air passage opening in the second group.

A further configuration consists in that the heat sink has a lateral surface which runs around the longitudinal axis and into which at least one ring of air passage openings, in particular in the first group, and in particular in addition at least one ring of air passage openings in the second group, is introduced, wherein an air baffle is associated in each case with at least some of the air passage openings, in particular in at least one of the groups. An inlet of air into air inlet openings and/or an outlet of air from the air outlet openings can be assisted by the air baffle, for example by preventing counterflows of air from passing to the corresponding openings or by virtue of the fact that air is deflected into the openings. Another configuration consists in that the heat sink has at least two tubular air baffles, which are arranged on the rest region for the at least one semiconductor light source of the semiconductor lamp, wherein the air baffles are arranged concentrically with respect to a longitudinal axis, and wherein at least one of the air passage openings provided in the rest region is arranged between the air baffles on the rest region. This results in the advantage that a particularly large and linear flow channel to or from the positioning face for the at least one semiconductor light source is provided. A particularly large heat dissipation area of the heat sink is also achieved. As a result, the rest area can be cooled particularly effectively. In particular, air can be dissipated particularly effectively out of the air passage openings provided in the rest region or introduced through said air passage openings. Such a heat sink also has a particularly simple design.

Yet a further configuration consists in that one of the tubular air baffles is configured as an outer wall of a driver housing. Thus, a particularly compact semiconductor lamp can be provided, which also assists in particularly efficient cooling of a driver accommodated in the driver housing.

A further configuration consists in that the heat sink has, at at least one end, a shape which is curved at least in a transverse profile (in a profile perpendicular to the longitudinal axis). The curved shape can in particular be a peripherally corrugated shape. This makes it possible, inter alia, to implement or arrange even a broad driver housing in the heat sink without a vertical flow of air being prevented. Such a heat sink is also simple to manufacture, in particular integrally.

A development consists in that the heat sink (in particular the lateral surface thereof) has a curved shape in a transverse profile (in a profile parallel to the longitudinal axis). The curved shape can be, for example, a shape with a plurality of steps. In particular, air passage openings can simply be fitted at a transverse region of a step (for example on an upper side), said air passage openings enabling a large flow cross section in the vertical direction in the event of a vertical alignment. The curved shape can also be a corrugated shape, for example. Then, air passage openings can be provided in particular in a region on the longitudinal side ends of the heat sink, with the result that a particularly long vertical air flow is made possible on the inner side of the heat sink, and thus particularly effective cooling is made possible. Owing to the step shape and the corrugated shape, a particularly large heat dissipation area can be achieved on a limited space in the case of at the same time a low number of pieces for producing the heat sink.

A development consists in that the heat sink has a plurality of vertically aligned struts arranged concentrically about the longitudinal axis of said heat sink. These struts can be fastened in a particularly simple manner, for example to a base, provide a good internal air throughflow, even in the horizontal alignment, and enable an integral configuration of the heat sink.

A specific development consists in that a driver housing can run at least partially into the struts.

Another development consists in that the heat sink and the bulb are formed by the same element, i.e. the bulb also acts as heat sink, or vice versa.

The type of air passage openings is not restricted and can include, for example, slots, holes, freeform openings etc.

Another configuration consists in that the heat sink forms a plurality of vertically aligned air channels which are substantially separate from one another. As a result, a horizontal flow component can be suppressed to a high degree.

The object is also achieved by a semiconductor lamp, which has at least one heat sink, as described above.

A semiconductor lamp can in particular be understood to mean a lamp which has at least one light source in the form of a semiconductor light source. Preferably, the at least one semiconductor light source includes at least one light-emitting diode. Given the presence of a plurality of light-emitting diodes, said light-emitting diodes can illuminate in the same color or in different colors. A color can be monochromatic (for example red, green, blue etc.) or multichromatic (for example white). The light emitted by the at least one light-emitting diode can also be an infrared light (IR LED) or an ultraviolet light (UV LED). A plurality of light emitting diodes can produce a mixed light, for example a white mixed light. The at least one light emitting diode can contain at least one wavelength conversion phosphor (conversion LED). The at least one light emitting diode can be present in the form of at least one individually housed light emitting diode or in the form of at least one LED chip. A plurality of LED chips can be mounted on a common substrate (“submount”). The at least one light emitting diode can be equipped with at least one dedicated and/or common optical element for beam guidance, for example at least one Fresnel lens, collimator or the like. Instead of or in addition to inorganic light-emitting diodes, for example on the basis of InGaN or AlInGaP, organic LEDs (OLEDs, for example polymer OLEDs) can generally also be used. Alternatively, the at least one semiconductor light source can have, for example, at least one diode laser.

The semiconductor lamp is preferably in particular a retrofit lamp since the described heat sink can be used particularly advantageously in retrofit lamps, which heat sink also provides a high degree of heat dissipation capacity given a limited physical space. The at least one semiconductor lamp has at least one semiconductor source and at least one connection (base) to a luminaire. Typically, the base is associated with a rear (with respect to the longitudinal axis) end or end region of the semiconductor lamp, while the at least one semiconductor lamp is associated with a front (with respect to the longitudinal axis) end region of the semiconductor lamp, and the semiconductor lamp emits light at least predominantly into a front half space.

The semiconductor lamp can in particular also have a driver for driving the at least one semiconductor light source, wherein the driver can be accommodated in particular at least partially in a driver housing.

A configuration consists in that the heat sink, together with another part of the semiconductor lamp, in particular with a driver housing and/or with an adjoining cover, forms at least one of the air passage openings. This at least one passage opening therefore does not need to be formed completely in the heat sink, which can considerably simplify production of the heat sink. In particular, a plurality of (relatively small) air passage openings can be produced from such an at least one air passage opening through the other part of the semiconductor lamp.

A further configuration is that the semiconductor lamp is a retrofit lamp, in particular an incandescent lamp retrofit lamp, which extends along a longitudinal axis and which has, at its front end, at least one semiconductor light source, over which an at least partially transparent cover arches, which, at its rear end, has a base and which has, between the cover and the base, the heat sink.

The semiconductor lamp can in particular have a driver housing between the base and the cover, which driver housing is surrounded by the heat sink.

A development consists in that the cover has at least one air passage opening. Thus, a flow of cooling air can be produced in the light source space delimited by the cover. In particular if at least one air passage opening is also likewise located in the rest region, a draught through the light source space can even be produced, which enables particularly good heat dissipation from the at least one semiconductor light source. The fact that the cover has at least one air passage opening can also mean that at least one air passage opening is provided in a rim of the cover and for example also can be delimited by the heat sink.

The cover can be in particular a bulb, for example, for an incandescent lamp retrofit lamp, or a planar cover, for example for a halogen lamp retrofit lamp.

The at least one semiconductor light source can be fitted to a front side of a printed circuit board, the printed circuit board resting with its rear side on the rest region of the heat sink, possibly over a layer of material with high thermal conductivity, such as a thermal interface material (TIM), for example of a thermally conductive adhesive, a thermally conductive paste or a thermally conductive film. The printed circuit board can in particular be populated on its front side also with at least one electronic component.

The invention will be described schematically in more detail in the following figures with reference to exemplary embodiments. In this case, identical or functionally identical elements have been provided with the same reference symbols for reasons of clarity.

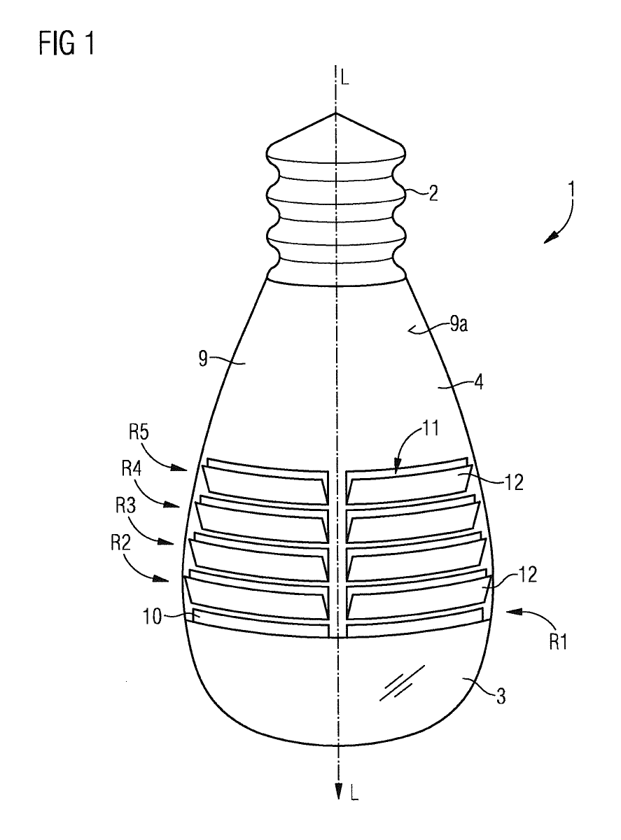

FIG. 1 shows, in a side view, a downwardly aligned LED incandescent lamp retrofit lamp in accordance with a first embodiment;

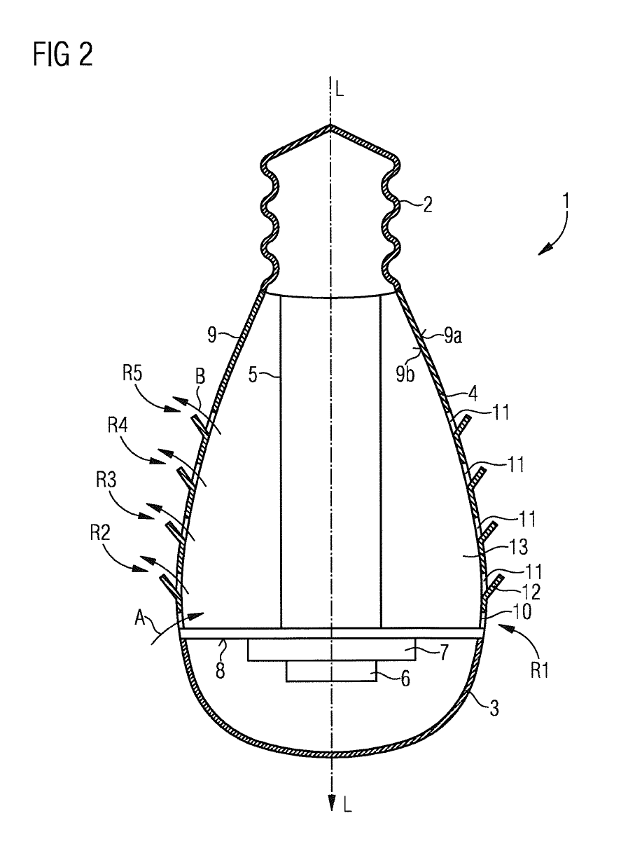

FIG. 2 shows the LED incandescent lamp retrofit lamp in accordance with the first embodiment as a sectional illustration in a side view;

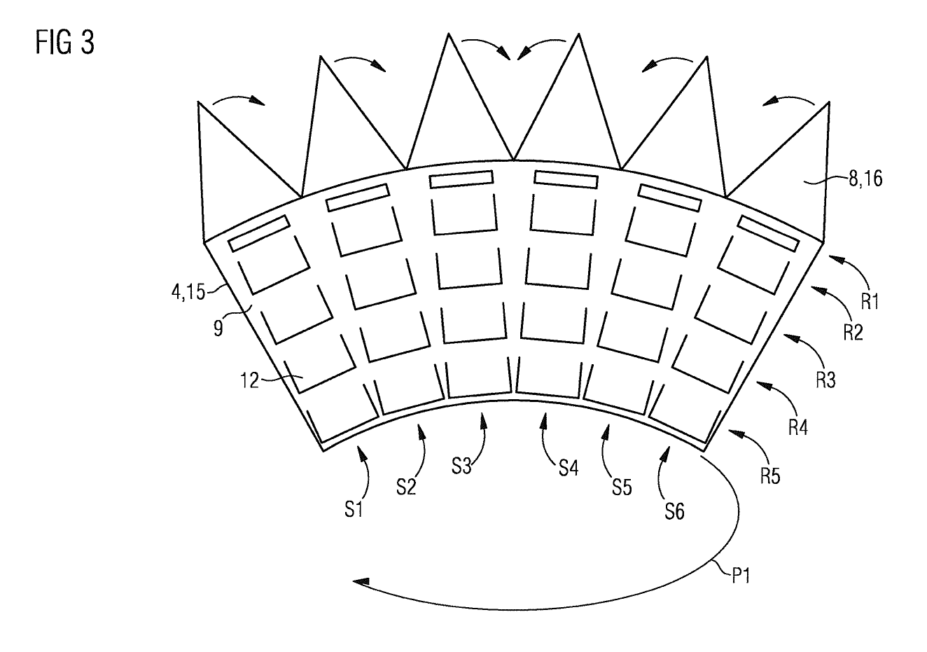

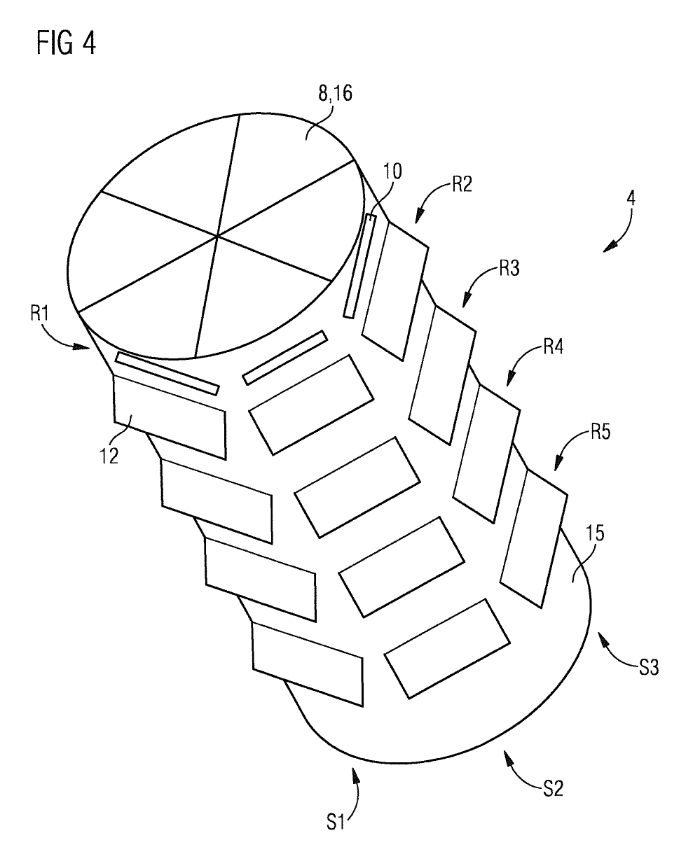

FIG. 3 shows, in plan view, sheet metal for producing a heat sink of the incandescent lamp retrofit lamp in accordance with the first embodiment;

FIG. 4 shows, in a view at an angle, the sheet metal shaped to form the heat sink shown in FIG. 3;

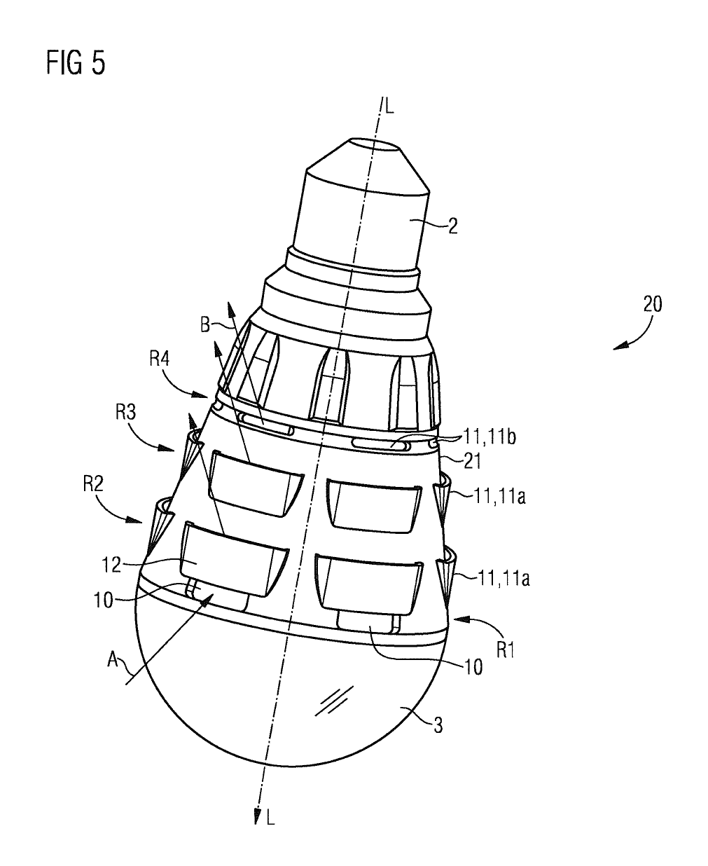

FIG. 5 shows, in a view at an angle, an LED incandescent lamp retrofit lamp in accordance with a second embodiment;

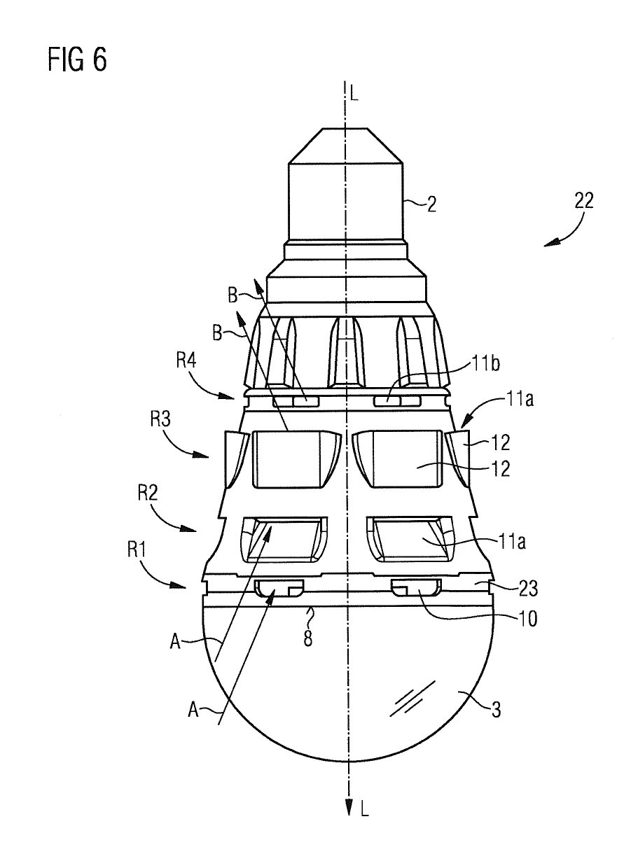

FIG. 6 shows, in a side view, an LED incandescent lamp retrofit lamp in accordance with a third embodiment;

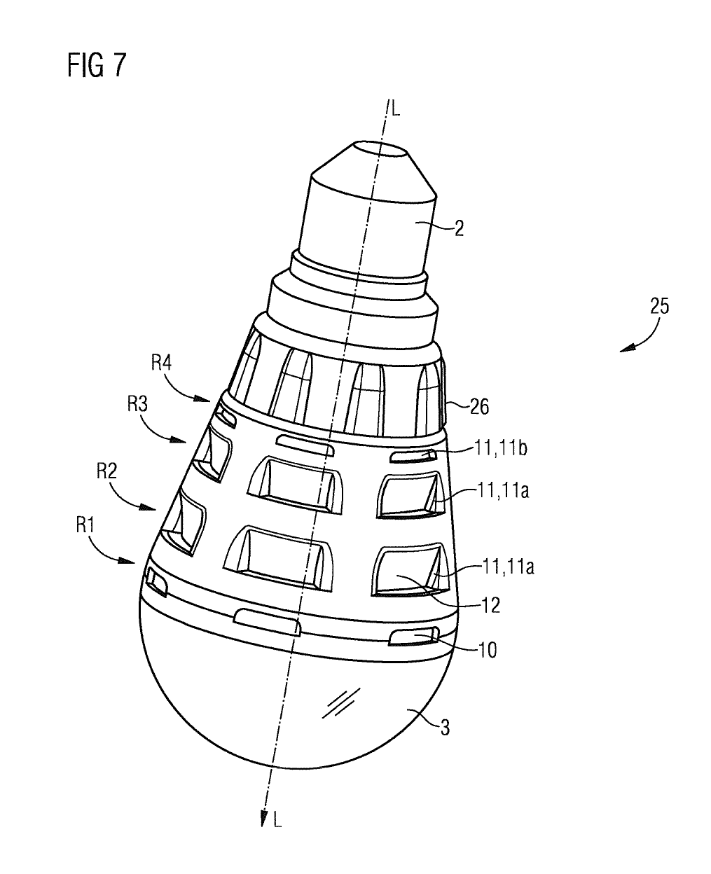

FIG. 7 shows, in a view at an angle, an LED incandescent lamp retrofit lamp in accordance with a fourth embodiment;

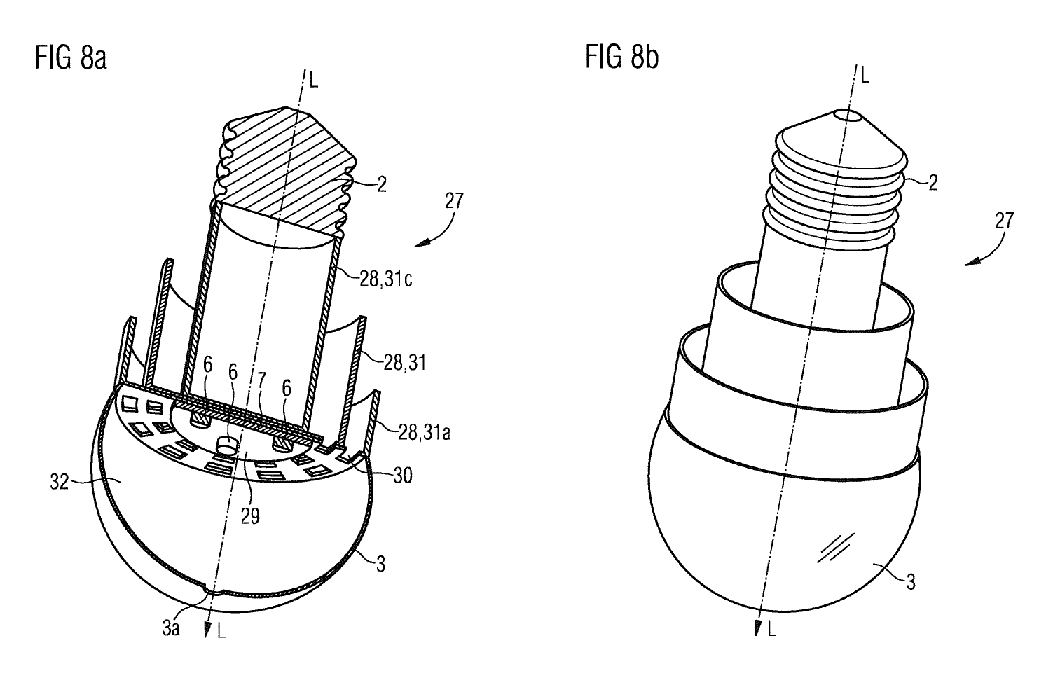

FIG. 8a shows, as a sectional illustration in a view at an angle, an LED incandescent lamp retrofit lamp in accordance with a fifth embodiment;

FIG. 8b shows, in a view at an angle, the LED incandescent lamp retrofit lamp in accordance with the fifth embodiment;

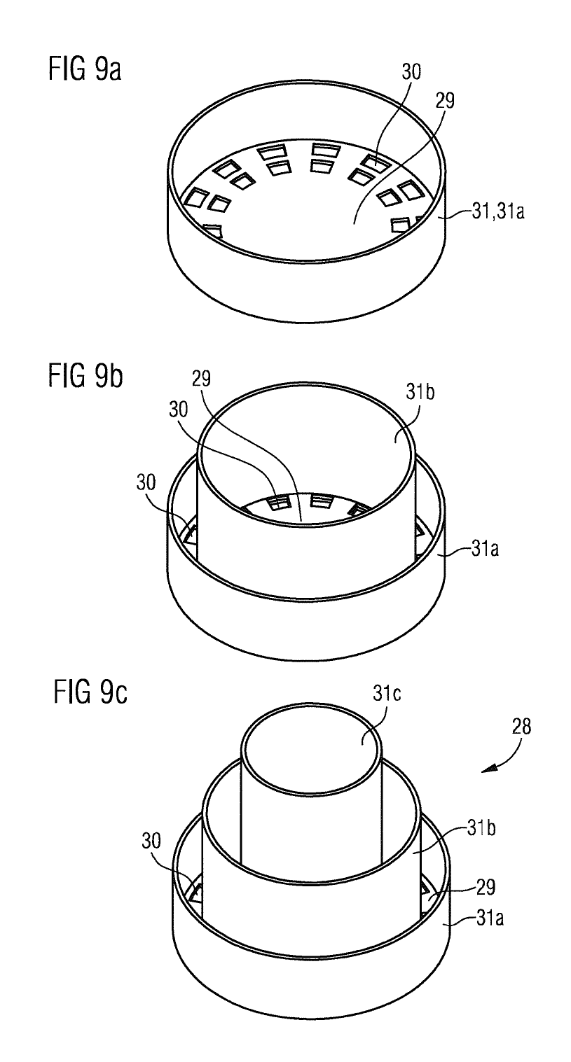

FIGS. 9a to 9c show, in a view at an angle from the top, three different states during assembly of the heat sink of the LED incandescent lamp retrofit lamp in accordance with the fifth embodiment;

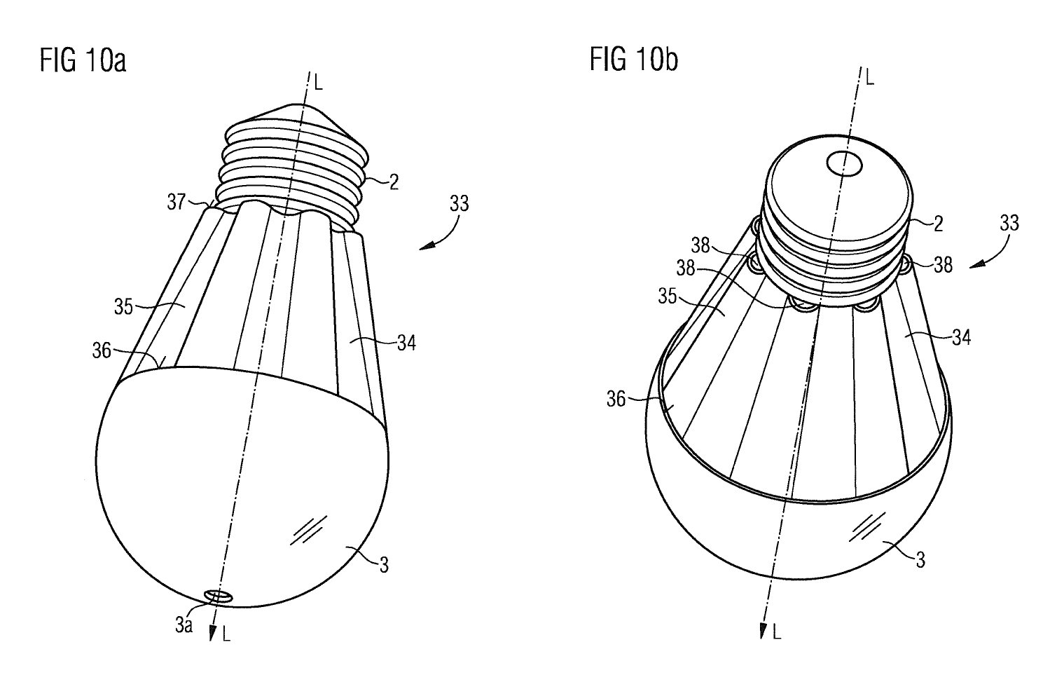

FIG. 10a shows, in a view from an angle, an LED incandescent lamp retrofit lamp in accordance with a sixth embodiment;

FIG. 10b shows, as an illustration from the side in another view at an angle, the LED incandescent lamp retrofit lamp in accordance with the sixth embodiment;

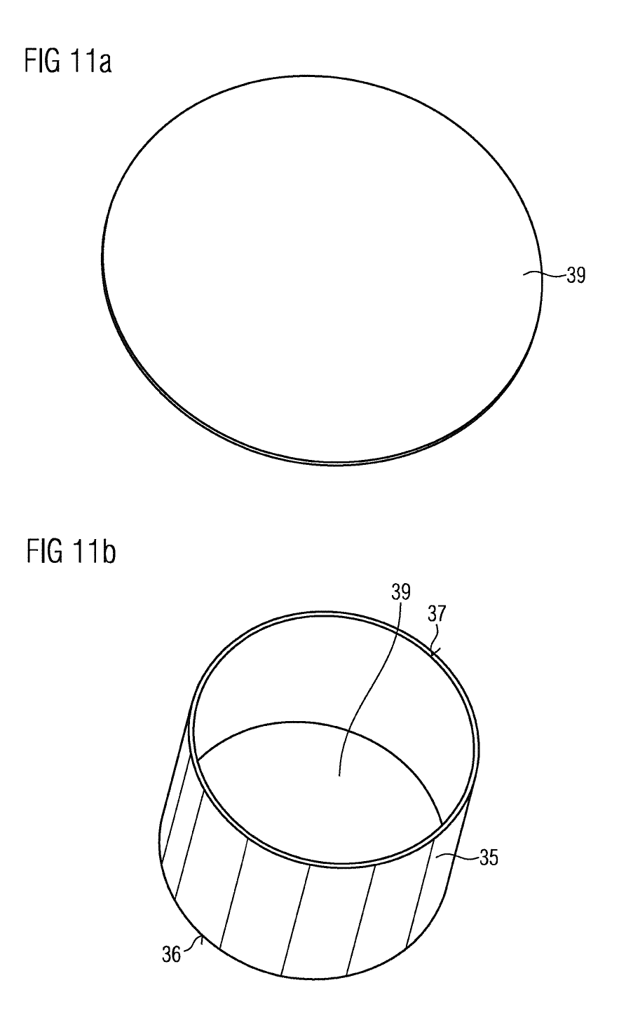

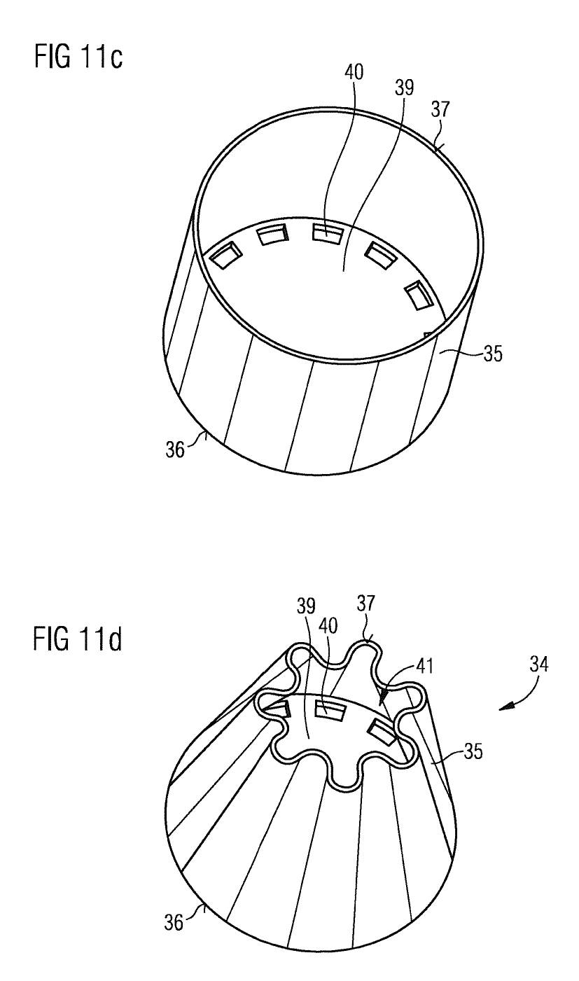

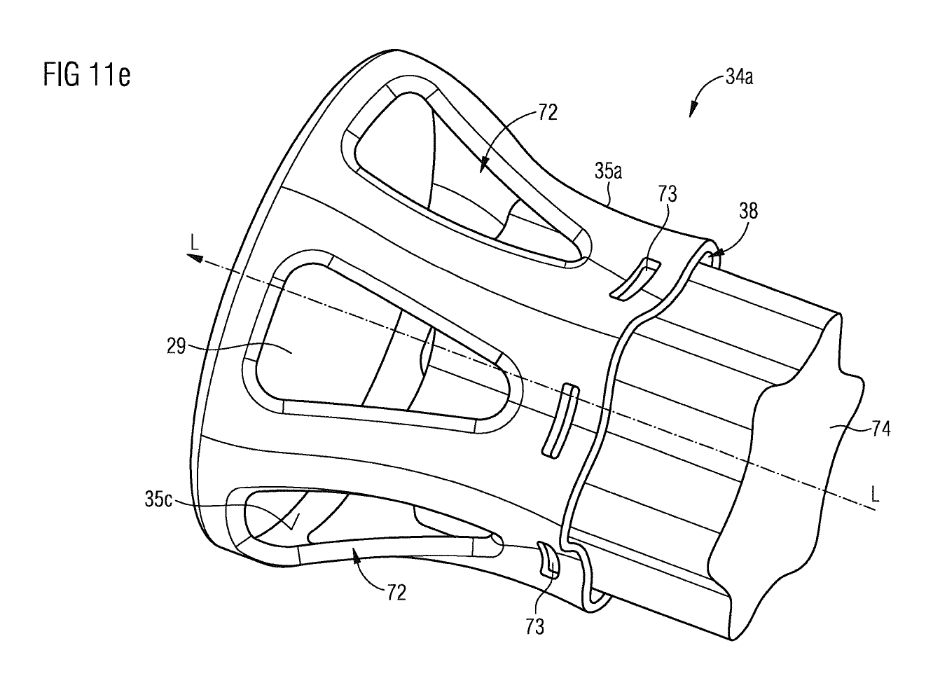

FIGS. 11a to 11d show, in a view at an angle from above, four different states during assembly of the heat sink of the LED incandescent lamp retrofit lamp in accordance with the sixth embodiment;

FIG. 11e shows a variant of the heat sink of the LED incandescent lamp retrofit lamp in accordance with the sixth embodiment with a tool still inserted;

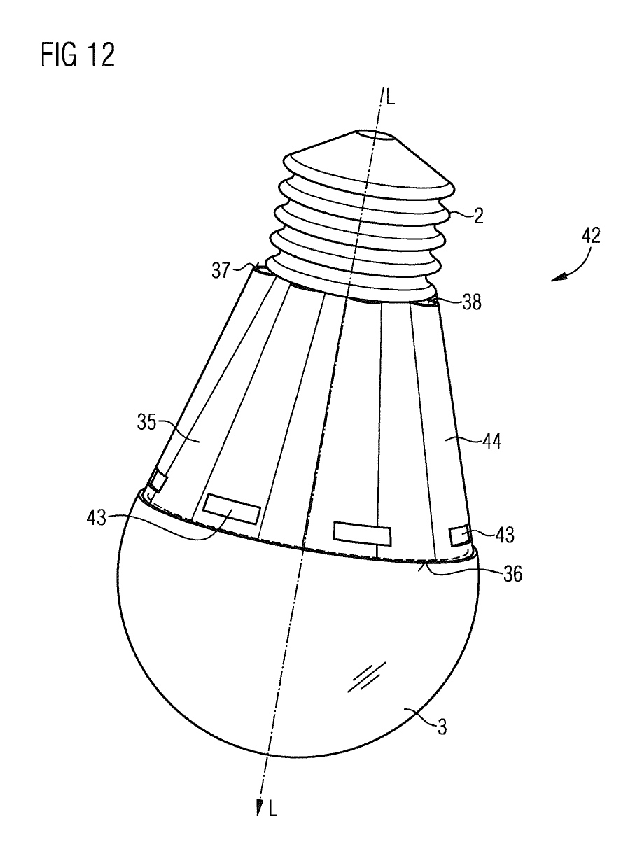

FIG. 12 shows, as an illustration at an angle in a side view, an LED incandescent lamp retrofit lamp in accordance with a seventh embodiment;

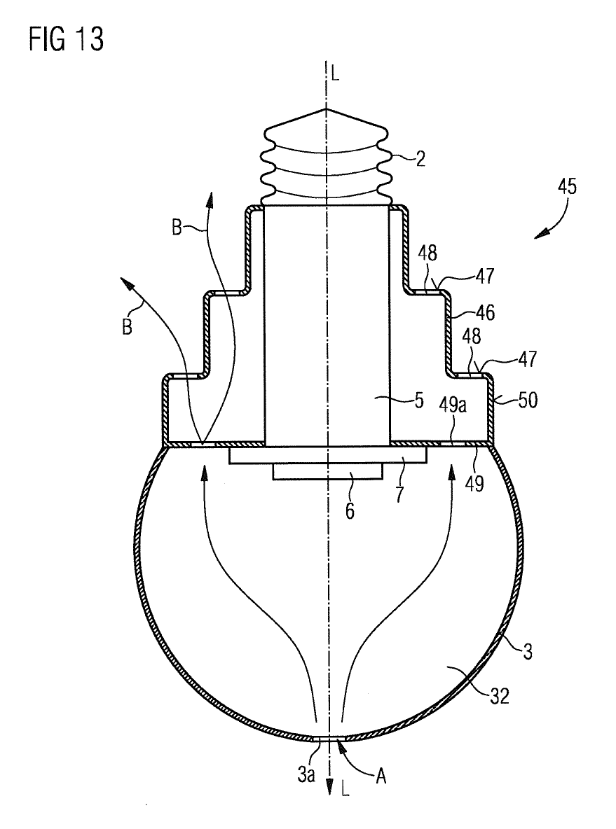

FIG. 13 shows, as a sectional illustration in a side view, an LED incandescent lamp retrofit lamp in accordance with an eighth embodiment;

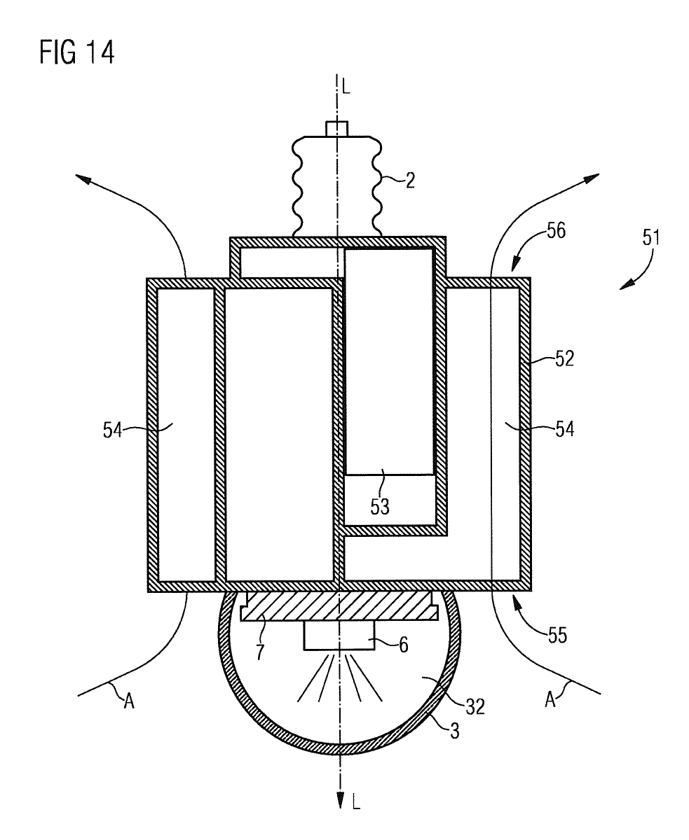

FIG. 14 shows, as a partially sectional illustration in a side view, an LED lamp in accordance with a ninth embodiment;

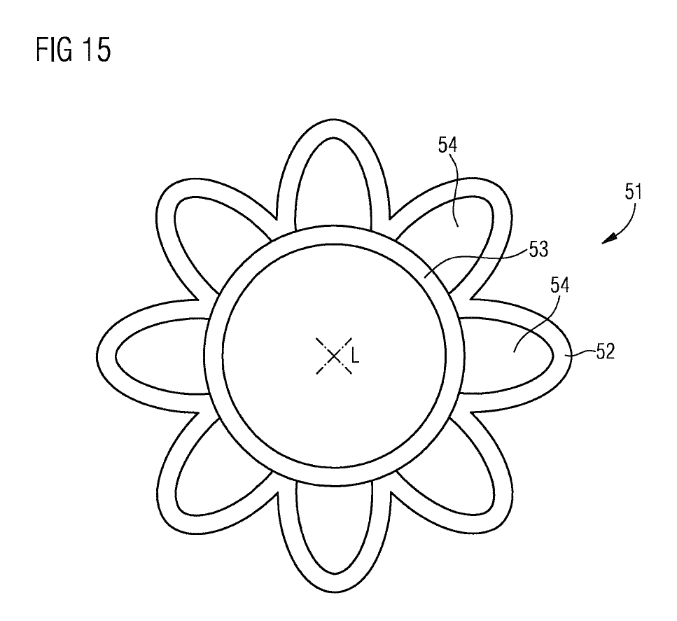

FIG. 15 shows the LED lamp in accordance with the ninth embodiment as a sectional illustration in a plan view;

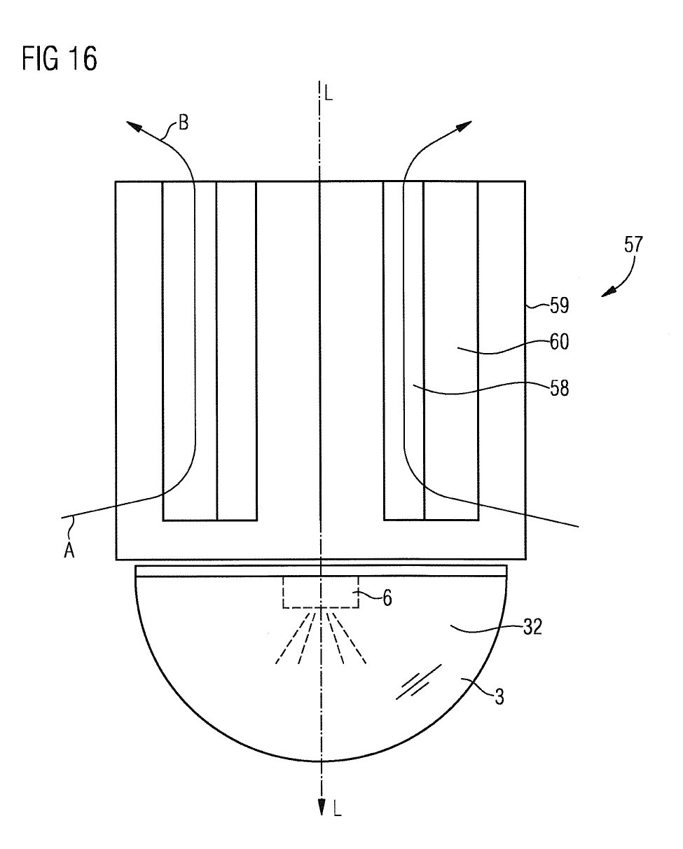

FIG. 16 shows, in a side view, an LED lamp in accordance with a tenth embodiment;

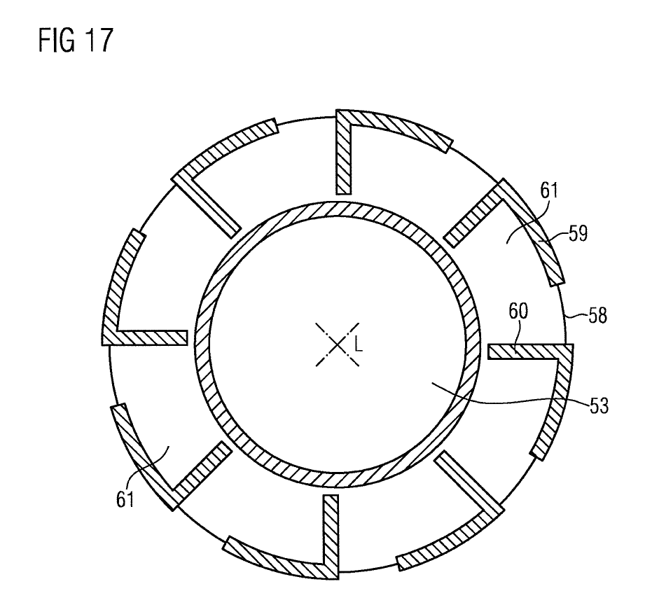

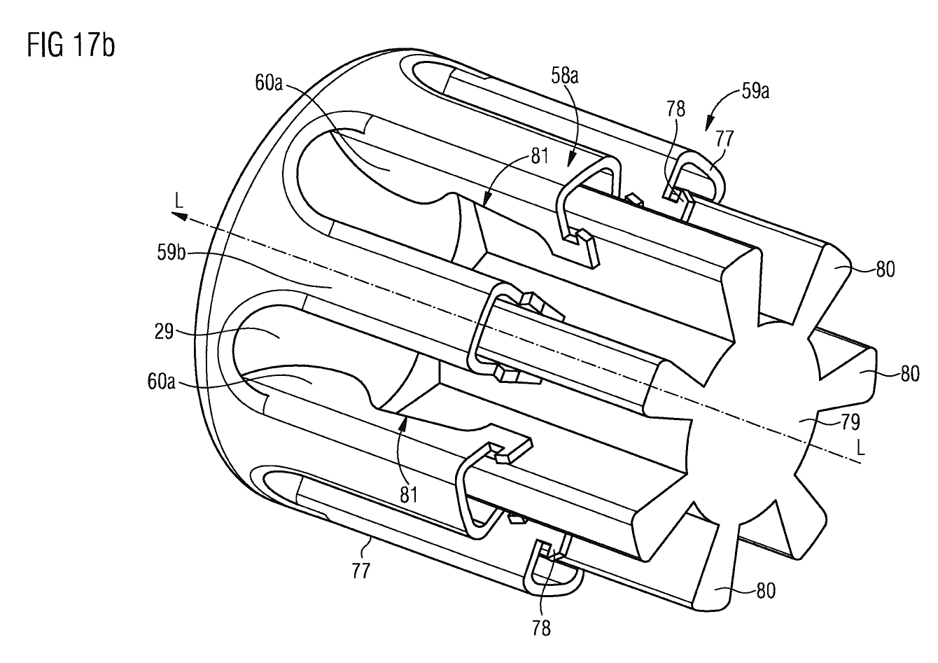

FIG. 17 shows the LED lamp in accordance with the tenth embodiment as a sectional illustration in a plan view;

FIG. 17b shows a variant of the heat sink of the LED incandescent lamp retrofit lamp in accordance with the tenth embodiment with a tool still inserted;

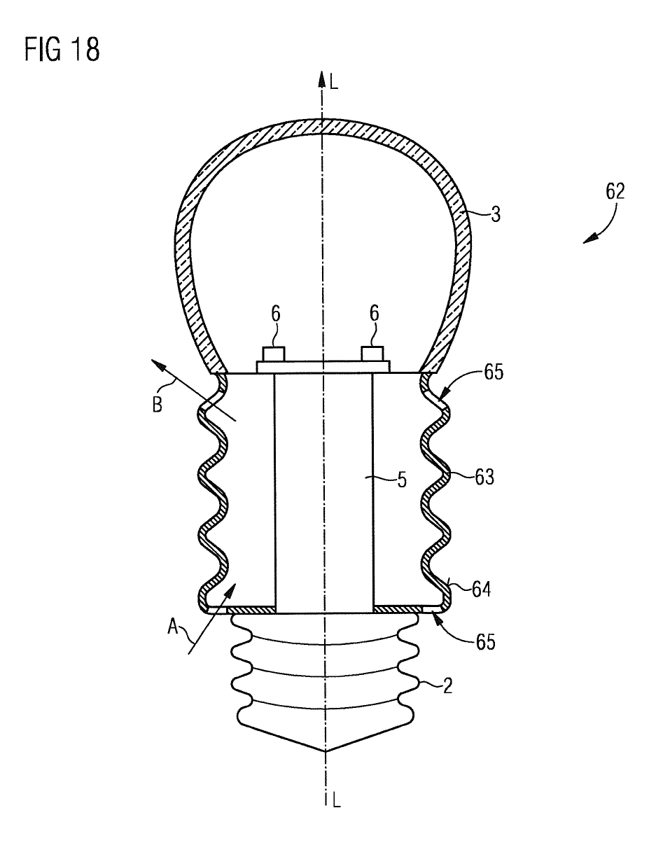

FIG. 18 shows, as a sectional illustration in a side view, an LED incandescent lamp retrofit lamp in accordance with an eleventh embodiment;

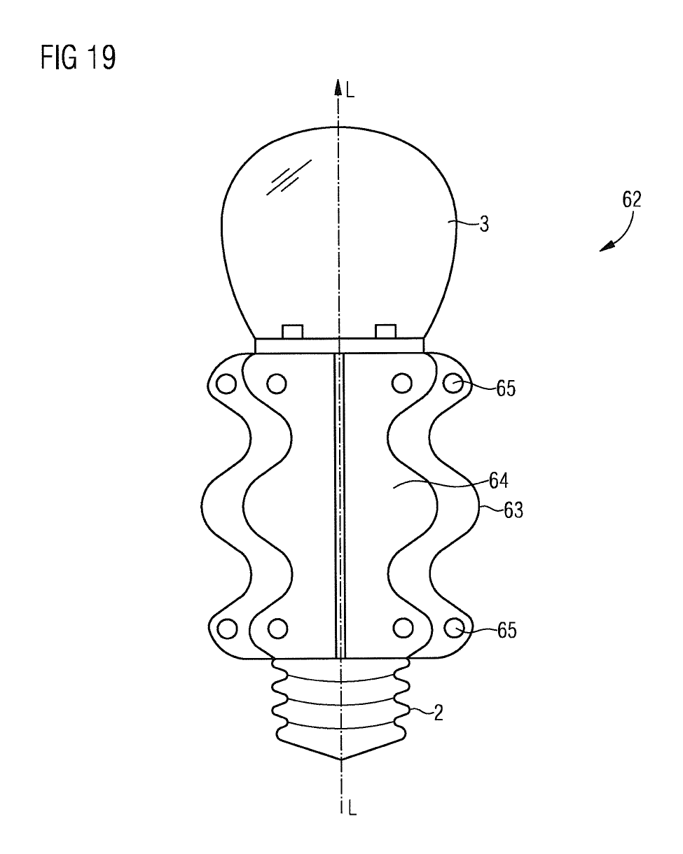

FIG. 19 shows, in a side view, the LED incandescent lamp retrofit lamp in accordance with the eleventh embodiment in an outwardly directed alignment;

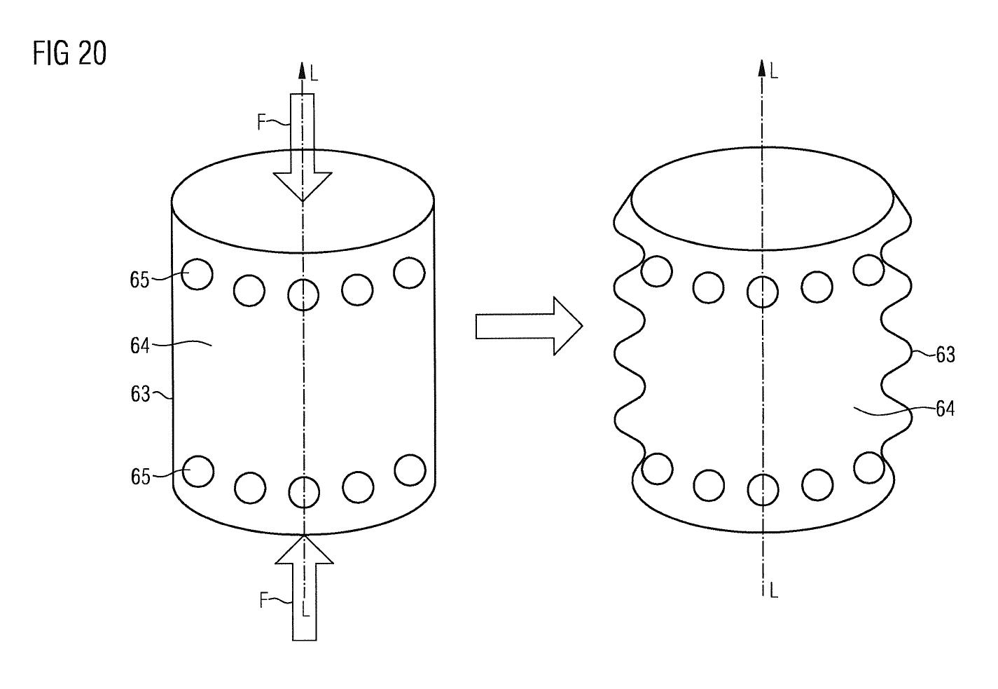

FIG. 20 shows a sequence for the production of a heat sink of the LED incandescent lamp retrofit lamp in accordance with the eleventh embodiment;

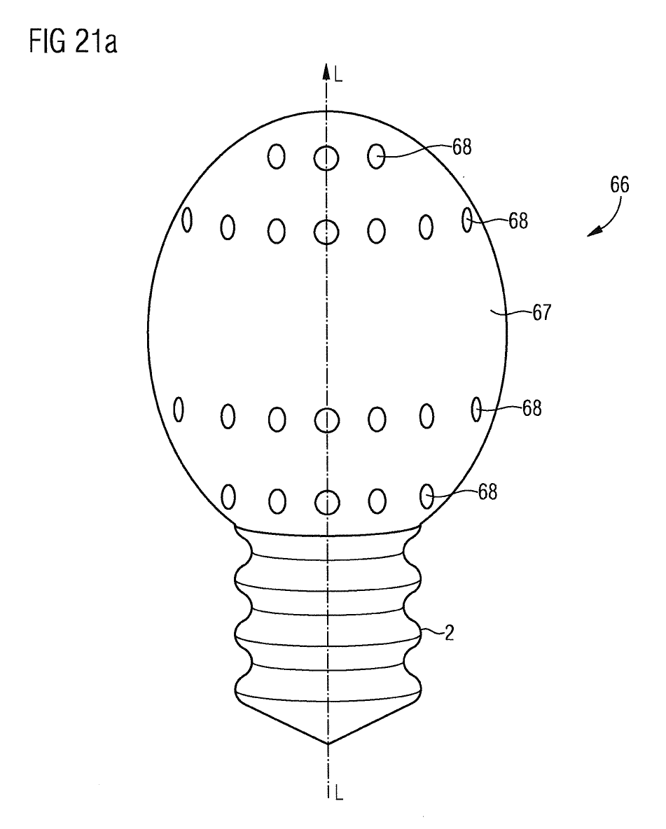

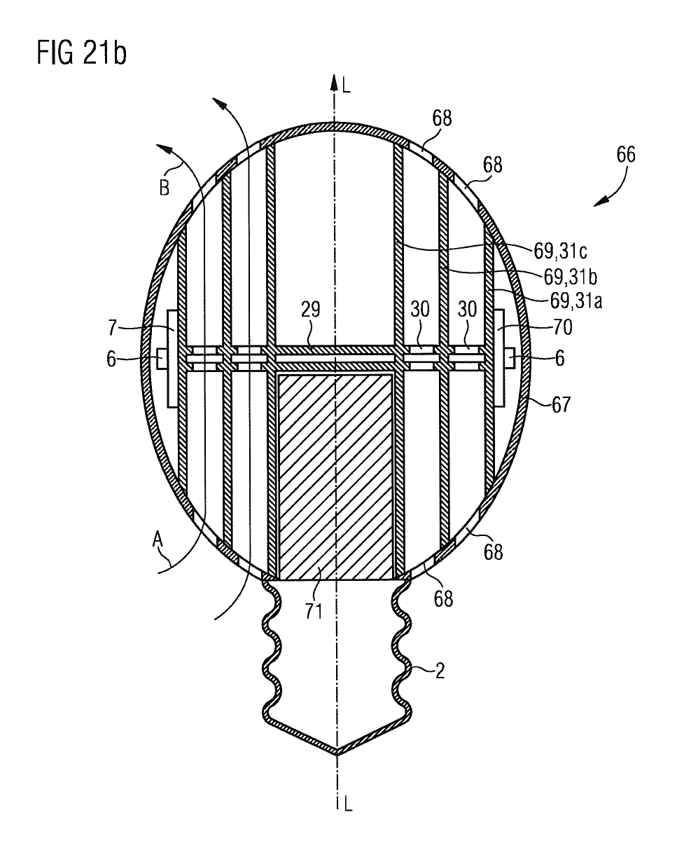

FIG. 21a shows, in a side view, an LED incandescent lamp retrofit lamp in accordance with a twelfth embodiment; and

FIG. 21b shows the LED incandescent lamp retrofit lamp in accordance with the twelfth embodiment, as a sectional illustration in a side view.

FIG. 1 shows, in a side view, a semiconductor lamp in the form of an LED incandescent lamp retrofit lamp 1 in accordance with a first embodiment, which is illustrated in a perpendicular, downwardly directed alignment or position. The perpendicular alignment or position in this case means that a longitudinal axis L of the lamp 1 is perpendicular. Such an alignment can be assumed, for example, when the lamp 1 is screwed into a downwardly directed lampholder of a luminaire. FIG. 2 shows the lamp 1 as a sectional illustration in a side view.

The lamp 1 has, at its lower end (which points upwards in the downwardly directed alignment illustrated), a base 2, which is in the form of a screw-type base, for example an Edison base. The upper end of the lamp 1, which points downwards in this case, has a cover in the form of a transparent bulb 3, which can consist of a transparent or opaque material. A heat sink 4 is located between the base 2 and the bulb 3.

The heat sink 4 surrounds a driver housing 5, in which a driver (not depicted) is located. The driver is electrically connected on the input side to the base 2 and on the output side to at least one semiconductor light source 6. The at least one semiconductor light source 6, which in this case includes at least one light emitting diode, can be mounted, for example, on a printed circuit board 7 acting as a substrate. To be more precise, a front side (downwardly pointing in this view) of the printed circuit board 7 is populated with the at least one semiconductor light source 6, while the printed circuit board 7 rests with its rear side (in this case pointing upwards) on a rest region 8 of the heat sink 4, possibly via a thermally conductive layer (not depicted). The rest region 8 of the heat sink 4 is in the form of a circular disk lying perpendicular to the longitudinal axis L.

A plurality of air passage openings 10, 11 are introduced in the region (“lateral surface region”) 9 extending from the bulb 3 up to the base 2, the outer area or outer side 9a of said region at the same time representing part of the outer contour of the lamp 1. The air passage openings 10, 11 are introduced distributed among different sections or levels along the longitudinal axis L, namely in the form of a ring or rotationally symmetrically with respect to the longitudinal axis L into the lateral surface 9 of the heat sink 4. The air passage openings 10 are in this case positioned directly at or in the vicinity of the rest region 8 and form a ring R1 of air passage openings 10. The air passage openings 11 are also positioned in the direction of the base 2 and in the process form four levels or rings R2 to R5, which are associated with the longitudinal axis L at a respectively different section, namely approximately equidistantly with respect to the longitudinal axis L.

While the air passage openings 10 are in the form of simple openings, each of the air passage openings 11 at the outer side 9a has an associated lamellar air baffle 12. The air baffle 12 directly adjoins a rim, facing the bulb 3, of the associated air passage opening 11 and extends at an angle outwards in the direction of the base 2.

In the downwardly aligned position shown, in particular cooling air A can enter the air passage openings 10, which therefore act as air inlet openings. The air which has entered passes over an inner side 9b of the heat sink 4, flows through an interior 13 and can then emerge from the air passage openings 11 as exhaust air B. The air passage openings 11 therefore act as air outlet openings. As a result, the air passage openings 10 are grouped into a first group of air passage openings 10, which act as air inlet openings, and a second group of air passage openings 11, which act as air outlet openings.

The air baffles 12 mean that no air flow upwards at the lamp 1 passes into the air passage openings 11 and thus impedes escape of the air heated in the interior of the heat sink 4. The lamp therefore enables particularly effective air flow in the interior of the heat sink 4 in particular in the vertical direction. As a result of the thus improved cooling of the heat sink 4, heat dissipation from the at least one semiconductor light source 6 can be improved. The intensified inner vertical air flow also has the result that the driver housing 5 can be cooled effectively over at least a large proportion of its length, which dramatically increases the life of the driver accommodated therein.

For the reverse case, in which the lamp 1 is aligned upwards (and therefore the base 2 points downwards and the bulb 3 points upwards), the cooling air can enter the interior of the heat sink 4 through the air passage openings 11, and these air passage openings therefore act as air inlet openings, and emerge through the air passage openings 10, which as a result act as air outlet openings. The air baffles 12 cause cooling air to be collected in this direction and intensify an air volume flow through the interior 13 of the heat sink 4.

Even in the case of a horizontal alignment, a cooling air flow still results through the heat sink 4, for example through the air passage openings 10, which partially act as air inlet openings (if they are directed downwards) or as air outlet openings (if they are aligned upwards), depending on the rotary position of the lamp 1.

FIG. 3 shows, using planar sheet metal 15, a possibility of producing the heat sink 4 integrally. The sheet metal 15 is sheet metal which is initially present in planar form and has been stamped out at its outer contour. For this purpose, the sheet metal 15 has regions 16 in the form of angle sectors (wedges), which together form the circular rest area 8. In each case four stamped-out lugs arranged one above the other in a column S1 to S6 are associated with each region 16 in that part of the sheet metal 15 which adjoins beneath the regions 16. The lugs correspond to the air baffles 12. The air baffles 12 at the same time form four rows, which correspond to the rows R2 to R5 of the air baffles 12 of the heat sink 4. In each case one air passage opening 10 has been stamped out between the lugs or air baffles 12 and the regions 16. The air passage openings 10 correspond to the row R1 of the heat sink 4.

The sheet metal 15 can be prepared in a simple manner from planar starting sheet metal by means of simple stamping operations. However, in addition to stamping, any suitable material-removing method is also suitable, for example cutting or erosion.

For the assembly of the heat sink, the sheet metal 15 is rolled up, as shown by the bent arrow P1, until the lateral edges abut one another or make contact with one another. The sheet metal 15 can be fixedly connected at this contact region, for example by means of welding.

Then, the regions 16 can be folded inwards and the air baffles can be bent or bent back inwards (into the resulting interior of the heat sink 4) and/or outwards. Thus, the finished heat sink 4 shown in a view at an angle in FIG. 4 is formed. The heat sink 4 shown in FIG. 4 is shown as an element with a cylindrical basic shape, merely in order to provide a simpler illustration, and can in principle also have all other forms which can be rolled together, in particular rotationally symmetrical forms. The rolling together can be performed with or without an introduction of bending edges. For example, rolling up can also mean bending along one or more bending edges, for example in order to produce not only a circular-cylindrical heat sink but for example also in order to produce a heat sink with a cylindrical basic shape which has a cornered, for example square or hexagonal, cross-sectional profile. The heat sink 4 is not restricted to a cylindrical basic shape either, but can also have relatively wide and relatively narrow sections along its longitudinal axis L, as shown in FIG. 1 and FIG. 2, for example, and can also be, for example, conical, cone-shaped or pyramid-shaped. In this case, it is advantageous that the basic shape of the heat sink 4 at least approximates a corresponding outer contour of a conventional lamp to be replaced and in particular does not exceed the outer contour of this lamp.

FIG. 5 shows, in a view from an angle, an LED incandescent lamp retrofit lamp 20 in accordance with a second embodiment. The lamp 20 has a similar construction to the lamp 1, with the heat sink 21 having a similar basic shape to the heat sink 4. Nevertheless, the air passage openings 11, which act as air outlets in the position of the lamp 20 which is aligned downwards at an angle, as is shown, have a different configuration. Thus, two rows or rings R2, R3 of air passage openings 11a are provided, which are covered in each case by an air baffle 12 analogously to the heat sink 4. A row R4 of air passage openings 11b arranged in the form of a ring about the longitudinal axis L, which row is arranged closer to the base 2, is configured, however, in such a way that said air passage openings (in a similar manner to the air passage openings 10) are comparatively small and also do not have an air baffle.

It is therefore generally possible for the air passage openings 11a, 11b in one group of air passage openings 11 to be configured differently, namely preferably in such a way that air passage openings 11a, 11b at the same height or in the region of an identical section of the longitudinal axis L (corresponding to the rings R2 to R4) have an identical configuration, but have a different configuration between different sections of the longitudinal axis L. Cooling air A therefore passes through the first group of air passage openings 10 into the heat sink 21 and passes out again through the second group of air passage openings 11a and 11b as heated exhaust air B. The air passage openings 11a and 11b form corresponding subgroups of the second group.

In this case, too, a function of the air passage openings can be altered in the event of a change in the vertical alignment, for example from a function as an air inlet opening to a function as an air outlet opening, or vice versa.

FIG. 6 shows, in a side view, an LED incandescent lamp retrofit lamp 22 in accordance with a third embodiment similar to the lamp 20, with the heat sink 23 now being configured in such a way that the air baffles 12 of the ring R2 of the air passage openings 11a are bent inwards in the direction of the interior of the heat sink 23. As a result, in the downwardly aligned position shown, the cooling air A can enter the air passage openings 11a of the ring R2 from outside, said air passage openings therefore acting as air inlet openings. The air passage openings 11 or 11a and 11b in the rows R3 and R4 have an identical design to the lamp 20 and act as air outlet openings for the exhaust air B. The lamp 22 therefore enables intensified inflow of cooling air A into the heat sink 23 in the position shown. In addition, given the reverse vertical position, an outflow of the exhaust air B located in the interior of the heat sink 23 is facilitated, with the result that, overall, an intensified air volume flow results.

The heat sink 23 can be produced from the same sheet metal 15 as the heat sink 21. It is therefore possible, by virtue of an easily convertible direction of the bending of the air baffles 12, to vary the air volume flow on the inner side of the associated heat sink 4, 21 or 23 in a targeted manner.

FIG. 7 shows, in a view at an angle, an LED incandescent lamp retrofit lamp 25 in accordance with a fourth embodiment, which has a similar design to the lamp 20. In this case, too, the level, row or ring R1 of air passage openings 10 of the heat sink 26 which is closest to the bulb 3 and the rest area 8 in the downward alignment shown represents a row of air inlet openings, while the three rings R2, R3, R4 closer to the base 2 act as air passage openings 11a, 11b, more precisely as air outlet openings. While, in the case of the heat sink 21 of the lamp 20, the air baffles 12 attach to the air passage openings 11a at an edge which points in the direction of the bulb 3 or the air passage openings 10 and the air baffle 12 are bent outwards, the air baffles 12 of the heat sink 26 of the lamp 25 are bent inwards and, for this purpose, attach to the air passage openings 11a at the edge pointing in the direction of the base 2.

FIG. 8a shows, as a sectional illustration, in a side view at an angle, an LED incandescent lamp retrofit lamp 27 in accordance with a fifth embodiment. FIG. 8b shows the lamp 27 in a view at an angle from the side. The heat sink 28 of the lamp 27 now has a rest region 29 in the form of a circular disk, with the printed circuit board 7, with in this case three light emitting diodes 6, being fitted centrally on the front side of said rest region, which front side is directed in the longitudinal direction L. The transparent bulb 3 arches over the front side of the rest 29. Two rings arranged concentrically to the longitudinal axis L and each having a plurality of cutouts 30 in the form of ring sectors are arranged in the rest region 29, to the side of the printed circuit board 12. The cutouts 30 directly adjoin the light source space 32 over which the bulb 3 arches.

In addition, a central air passage opening 3a is located in the frontmost region of the bulb 3, i.e. at its apex.

Three tubular air guide elements are arranged concentrically to the longitudinal axis L on the rear side of the rest region 29, which points in the direction of the base 2.

An outer air guide element 31a adjoins an outer rim of the rest region 29 and has the greatest diameter of the three air guide elements 31 as well as the shortest length (along the longitudinal axis L).

An inner tubular air guide element 31c has the smallest diameter of the three tubular air guide elements 31, but the greatest length. In particular, its diameter is so small that it is smaller than the smallest ring of the cutouts 30. The inner air guide element 31c is therefore substantially covered at its front end by the rest region 8. The inner air guide element 31c also at the same time acts as a driver housing 5, with a driver being accommodated in the interior of said driver housing. The lower end of the inner air guide element 31c is terminated by the base 2.

A central tubular air guide element 31b, which has a diameter which is between a diameter of the larger ring of the cutouts 30 and the smaller ring of the cutouts 30, is located between the air guide elements 31a and 31c. The length of the air guide element 31b is between the length of the inner air guide element 31c and the length of the outer air guide element 31a.

In the case of operation in the downwardly directed vertical alignment, or as shown, in a substantially downwardly directed alignment of the lamp 27, cooling air can enter the light source space 32 through the central air passage opening 3a and emerge again through the cutouts 30. A draught of air is produced through the light source space 32, and this draught of air can effectively cool the light emitting diodes 6.

Since the air guide elements 31a to 31b are accessible for cooling air both on their outer side (the side remote from the longitudinal axis L) and with their inner side (the side facing the longitudinal axis L), said air guide elements enable effective cooling of the rest region 29 owing to their large cooling surface area. In addition, by virtue of the air flow directed in the longitudinal direction L, the driver located in the inner air guide element 31c, which acts as driver housing, is cooled particularly effectively.

The graduated length of the air guide elements 31a to 31c serves the purpose of enabling the use as incandescent lamp retrofit lamp, since an outer contour of a conventional incandescent lamp can be maintained at least approximately.

In the case of a reverse alignment, cooling air can be transported in a targeted manner vertically to the cutouts 30 and pass into the light source space 32, which likewise effects cooling of the semiconductor light source or LEDs 6. In this case, too, the tubular air guide elements 31 also enable effective cooling of the rest region 29.

FIG. 9a to FIG. 9c show, in a view at an angle from above, three different states during assembly of the heat sink 28.

FIG. 9a shows the rest region 29, already provided with the two concentric rings of cutouts 30, with the outermost, shortest tubular air guide element 31a having been fastened to the lateral rim of said rest region. Alternatively, the body 29, 31a shown can also be integral, for example can be produced by means of deep-drawing.

In the next steps, the central, medium-length tubular air guide element 31b (FIG. 9b) is fastened on the rest area 29 between the two rings of cutouts 30, for example by means of laser welding, and in addition, the inner, longest tubular air guide element 31c is positioned onto the rest region 29 in such a way that it is surrounded laterally by the cutouts 30. Alternatively, the air guide element 31b and/or the air guide element 31c can also each be part of a box-shaped body, similar to the box-shaped body 29, 31a, for example, wherein the three box-shaped bodies or air guide elements 31a, 31b and 31c are connected to one another in the rest region. The air guide elements 31 and the cutouts 30 are arranged concentrically with respect to one another and with respect to the longitudinal axis L of the heat sink 28. FIG. 9c shows the completely assembled heat sink 28. In this case, the heat sink 28 is therefore assembled from only three or four sheet-metal parts.

FIG. 10a shows an LED incandescent lamp retrofit lamp 33 in accordance with a sixth embodiment in a view at an angle from the side. FIG. 10b shows the lamp 33 in an angled view at a different angle.

The associated heat sink 34 is now configured in such a way that its lateral surface area 35 is completely closed. In addition, the lateral surface 35 tapers starting from the bulb in the direction of the base 2 with a diameter which decreases in size. At the same time, the cross-sectional profile of the lateral surface 35 (in a plane perpendicular to the longitudinal axis L) has a peripheral or closed corrugated design which increases in size the closer it gets to the base 2. At its rim 36 which abuts or adjoins the bulb 3, the lateral surface 35 of the heat sink 34 still has a shape which is circular in cross-sectional profile and which corresponds, in terms of diameter, at least approximately to the diameter of the rim of the bulb 3. At its lower rim 37 adjoining the base 2, the lateral surface area 35 has a very corrugated form, with a diameter of an inner contour of the cross-sectional profile preferably being slightly greater than a cross-sectional dimension of a driver housing (not depicted) to be arranged within the heat sink 34. A diameter of the outer contour of the cross-sectional profile at the lower edge 37 is greater than a diameter of the base 2, with the result that rear air passage openings 38 are produced which are distributed rotationally symmetrically about the longitudinal axis L and correspond to in each case one outwardly directed corrugation peak of the lateral surface 35. There is therefore no need for any air passage openings to be especially introduced, for example stamped out, at the lower rim 37.

If, at the same time, the rest region of the heat sink 34 has at least one cutout, in the at least substantially downwardly aligned (slightly at an angle) position of the lamp 33 as shown, cooling air can enter the light source space through the air passage opening 3a in the bulb 3, then flow through the light source space and then escape again from the light source space through the cutouts in the rest region. Then, the air flows along the inner side of the heat sink 34 as far as the air passage openings 38, which point in the direction of the base 2. The heat sink 34 also enables effective cooling of the rest region, wherein the cooling capacity is increased by the degree of corrugation or undulation of the lateral surface area in comparison with a monotonously curved lateral surface area.

In an alternative configuration, air passage openings can also be introduced in the lateral surface area 35, for example similar to the air passage openings 10, 11 shown for the lamps 1 and 20.

FIG. 11a to FIG. 11d show different stages of assembly of the heat sink 34, with FIG. 11d showing the completely assembled heat sink 34.

FIG. 11a shows a rest in the form of a circular disk or such a rest region 39, with a tubular attachment being fitted to the outer rim thereof, as shown in FIG. 11b, said attachment corresponding to the lateral surface area 35. In a further step (or alternatively already prior to the application of the attachment forming the lateral surface area 35), ring-shaped cutouts 40 are introduced into the rest region 39, in this case in the vicinity of the outer rim, as shown in FIG. 11c. In the text which follows, the attachment forming the lateral surface area 35 is plastically deformed, as shown in FIG. 11d. A driver housing can be introduced, for example inserted, into the heat sink 34 through a resultant rear opening 41 in the lateral surface area 35 or in the heat sink 34. The driver housing can have a cylindrical basic shape, for example.

The heat sink 34 can also be referred to as a hollow body with a basic shape in the form of a truncated cone or a covering area which is open at its narrower end, wherein the lateral surface area 35 increases in terms of its corrugated nature from the upper covering area (which is formed by the rest region 39) to the open covering area.

The heat sink 34 can also be manufactured integrally, as is described in more detail with reference to FIG. 11e below.

FIG. 11e shows, in a view at an angle from below, a heat sink 34a in yet another variant. The heat sink 34a has a similar design to the heat sink 34 and tapers towards an end near the base and is formed with an increasingly corrugated nature in cross-sectional profile. In contrast to the heat sink 34, the heat sink 34a now has large air passage openings 72 in its lateral surface area 35a, which air passage openings extend in particular over more than half the length or height of the heat sink 34a. This heat sink 34a enables intensified throughflow at its inner side 35c given a horizontal alignment.

The corrugated nature of the heat sink 34a can be achieved by virtue of a tool 74, for example a stamp, being introduced into the cup configured similarly to FIG. 11c. The tool has the desired corrugated shape on its lateral-surface-side outer face. The tool 74 does not need to be inserted completely or so as to bear against the rest region 29, but it can. As a result, by lateral pressure being exerted on the lateral surface area 35a of the heat sink 34a, the lateral surface area can be plastically deformed so as to match the corrugated shape. This solves the problem of it otherwise no longer being possible to remove a tool which has been introduced into the cup shown in FIG. 11b after a bending operation. As a result of the corrugated deformation, the material is additionally subjected to only a slight stress given this bending. However, other forms and also bending on a round stamp are also conceivable.

The large air passage openings 72 can be created by a stamping-out operation. In one variant of this, some of the material can be bent back inwards peripherally, with the result that small air guide fins or air guide walls are produced which additionally extend the cooling area (not shown).

The large air passage openings 72 additionally also influence the deformation response of the lateral surface area 35a, for example, with respect to a curvature in the longitudinal direction. As a result of a corresponding variation of the form and/or size of the air passage openings 72, the basic shape of the longitudinal profile can thus also be influenced in a targeted manner. Small cutouts 73 in the rear end of the heat sink 34a are used for snap connection with a housing, for example a plastic housing, which can be used as a driver housing, for example. In addition, cutouts in the front end of the heat sink 34a can also be introduced (not depicted), in order to also enable latching of a bulb, in particular a plastic bulb, or the like, for example.

FIG. 12 shows, in a view at an angle from the side, an LED incandescent lamp retrofit lamp 42 in accordance with a seventh embodiment, which has a similar design to the lamp 33, but now has, in addition to or as an alternative to the cutouts 40, cutouts 43 in the heat sink 44 which run peripherally in the form of a ring in the vicinity of the bulb 3. As a result, in particular an inflow of cooling air into the interior of the heat sink 44 (or the exhaust air thereof, in particular in the opposite position) can be intensified, which results in even more effective cooling. Alternatively, the cutouts 43 can be used for fastening the bulb 3, for example as latching cutouts.

FIG. 13 shows, as a sectional illustration in a side view, an LED incandescent lamp retrofit lamp 45 in accordance with an eighth embodiment, the heat sink 46 now having a graduated form in longitudinal profile, with transverse sections or upper sides 47 of the respective steps being provided with cutouts 48 arranged in the form of a ring around the longitudinal axis L. At the same time, a plurality of cutouts 49a are located in the rest region 49 of the heat sink 46, with the result that air can flow through a central air passage opening 3a, through the light source space 32 and then through the cutouts 49a out of the light source space 32 into the interior of the heat sink 46 and from there into the air passage openings 48. As a result, similar advantages are achieved as in the case of the lamp 33.

In this case too, openings can be introduced into the side faces 50 of the heat sink 46 in addition to or as an alternative to the cutouts 49.

The heat sink 46 can likewise be in the form of an integral sheet-metal part, for example formed by means of stamping, possibly bending and/or deep-drawing.

FIG. 14 shows a sketch of an LED lamp 51 in accordance with a ninth embodiment in a side view in partial section. The heat sink 52 surrounds a driver housing 53 in such a way that the heat sink 52, together with the driver housing 53, has a plurality of vertically aligned air channels 54 arranged symmetrically around the longitudinal axis L. The air channels are configured and arranged in such a way that they are arranged laterally to the side of or outside of the rest region and of the bulb 3, with the result that they have free openings and air channels 54, in a plan view of the lamp 51 from the direction of the bulb 3, as is also shown in FIG. 15. The air channels 54 therefore do not open into the light source space 32.

In the downwardly aligned position of the lamp 51 shown, cooling air A can therefore flow into an open end 55 of the air channels 54, flow through the air channels 54 and flow out again at an opposite end 56. As a result, a very considerable air volume flow of cooling air A is achieved given at the same time a particularly large heat transfer area of the heat sink 52.

Alternatively, the heat sink 52 can rest or sit on the rest area, with cutouts (for example stamped-out portions) being provided in the rest area which open into the adjoining openings in the air channels 54. The cutouts are preferably matched to the corrugated cross-sectional profile of the air channels 54 for a strong air flow.

FIG. 15 shows a cross section perpendicular to the longitudinal axis L through the lamp 51 shown in FIG. 14 at the height of the heat sink 52. The round driver housing 53 is surrounded symmetrically by a plurality of cooling channels 54. This enables particularly effective cooling of the driver housing 53 as well. The driver housing 53 in this case forms an inner rim of the cooling channels 54, with the cooling channels 54 being configured and arranged in a form of a flower.

The heat sink 52 can be formed as an integral sheet-metal part, for example by virtue of a sheet metal strip being shaped in such a way that it has a corrugated, for example sinusoidal, serrated, theta-shaped or otherwise suitable periodic shape in the longitudinal profile along its longitudinal axis. The thus shaped sheet-metal strip can then be laid, for example in the form of a cuff around the driver housing 53 (or another object), and then fastened. The heat sink 52 can generally be a bellows-shaped element.

FIG. 16 shows an LED lamp 57 in accordance with a tenth embodiment, in which the air passage openings 58 are now introduced into the associated heat sink 59 as lateral, vertically running slots and run as far as the rear end of the heat sink 59. The material into which the air passage openings 58 are stamped is used as an inwardly bent-back air baffle 60, in particular as an air baffle 60 which points radially inwards as a result of the bending, as is illustrated in FIG. 17 as well in cross section perpendicular to the longitudinal axis. As a result, vertically aligned air channels 61 are provided in the heat sink 59 together with the driver housing 53 and enable particularly effective cooling of the lamp 57, in particular in a vertical alignment.

The heat sink 59 can be constructed from only one sheet-metal part, for example, as will now be explained similarly with reference to FIG. 17b. In this regard, FIG. 17b shows, in a view at an angle from below, a heat sink 59a in accordance with a variant modified with respect to the heat sink 59. The heat sink 59a now has a lateral surface area 59b, into which slot-like air passage openings 58a which are aligned in a longitudinal direction are introduced rotationally symmetrically and thus form hollow struts 77. The hollow struts are arranged symmetrically on an outer rim of the rest region 8 around the longitudinal axis L and are inwardly open. The hollow struts 77 now each have an inwardly bent air baffle 60a, which points substantially radially inwards, on both longitudinal sides of said hollow struts.

The air baffles 60a can be shaped by means of a tool 79, which is now formed in cross section in such a way that it has lateral, vertically extending projections 80, which are arranged rotationally symmetrically with respect to the longitudinal axis L in a pattern conforming to the hollow struts 77 (to be produced). Therefore, after a preceding stamping or cutting operation, the air baffles 60a can be bent so as to bear with a respective projection 80. The tool 79 can be withdrawn again easily after the bending operation.

At their lower end, the struts 77 each have latching hooks or latching tabs 78 for fastening to the base. For fastening purposes, the hollow struts 77 can be pushed slightly inwards and detensioned again for engagement in a corresponding mating latching element, for example the base. The heat sink 76 is therefore particularly easy to fit.

The air baffles 60a or the hollow struts 77 make it possible, in particular with an inserted housing similar to that shown in FIG. 17, for air to be guided vertically even in the case of an only slightly off-vertical alignment, while at the same time, an air flow transverse to the heat sink 59a is made possible also by lateral recesses 81 at the inner edges of the air baffles 60a, in particular in the case of a horizontal alignment. In this case, too, a driver housing can be inserted form the rear between the struts, for example a cylindrical driver housing 53.

Cutouts can also be provided in the rest region 29.

The heat sink 59a can be configured as an integral sheet metal bending part, for example.

The heat sink 59 can be produced in a similar manner.

FIG. 18 shows, as a sectional illustration in a side view, an LED incandescent lamp retrofit lamp 62 in accordance with an eleventh embodiment, whose heat sink 63 now has a bellows-like lateral surface area 64 or side wall, which is corrugated in a longitudinal profile (in a plane parallel to the longitudinal axis L). As a result, an enlarged cooling surface area and/or a particularly compact design in the direction of the longitudinal axis L is made possible. FIG. 19 shows the lamp 62 in a side view in an upwardly directed alignment. Cutouts 65 are introduced into the heat sink 63 in each case in the region of its longitudinal-side ends, while a long region of the lateral surface area 64 lying therebetween is completely enclosed peripherally. As a result, cooling air A can enter the heat sink 63 only at one of the end regions of the lateral surface area 64 and can leave the heat sink 63 again as exhaust air B in the vicinity of the other end only once it has passed through a large length of the heat sink 63. Thus, an inner air flow through the heat sink 63 over a large length is also achieved, as a result of which the heat sink 63 and a driver housing 5 provided in the heat sink 63 can be cooled particularly effectively in the case of a vertical alignment of the lamp 62.

FIG. 20 shows a sequence for producing the heat sink 63, wherein, in the left-hand part of the image, a hollow cylinder which is open at one end and has a circular cross-sectional profile (other profile forms are alternatively also possible) is shown, with the cutouts 65 acting as air passage openings already having been introduced into the lateral surface area 64 of said hollow cylinder. As a result of a compressive force F acting in the direction of the longitudinal axis L on the cover faces or open ends of the in this case still unfinished heat sink 63, which is shown in the left-hand part of the figure, the heat sink 63 is compressed and thus assumes its corrugated shape. This embodiment has the advantage that the heat sink 63 can be produced integrally and in a particularly simple manner. The heat sink may also additionally have, for example, a corrugated shape, a ribbed shape or another suitable shape in cross-sectional profile.

FIG. 21a shows, in a side view, an LED incandescent lamp retrofit lamp 66 in accordance with a twelfth embodiment, in which a transparent bulb 67, which can be manufactured from a polymer, for example, in particular in more than one piece, now rests directly on the base 2. For this purpose, bulb openings are introduced in each case in a lower end region and an upper end region of the bulb 67 in the form of a ring and rotationally symmetrically around the longitudinal axis L, while the bulb 67 is otherwise closed peripherally between its end regions. As a result, in a fashion similar to the principle shown in FIG. 18, air can enter the bulb openings 68 at one of the end regions and leave the bulb 67 again through the bulb openings 68 at the other end region. The shown embodiment has the advantage that, in this case, not only the driver is cooled directly by the air flowing into the heat sink or the bulb 67, but also the printed circuit board and the light emitting diodes can be subjected directly to an air flow, which can provide particularly effective cooling.

FIG. 21b shows the LED incandescent lamp retrofit lamp 66 as a sectional illustration in a side view in a possible development.

In its lamp interior surrounded by the transparent bulb 67, the LED incandescent lamp retrofit lamp 66 is equipped with a heat sink 69, which is constructed in similar fashion to two heat sinks 28, which are offset with respect to one another through 180° and are connected at their rest area 29 (see, for example, FIG. 9c). As a result, two sets of tubular air guide elements 31a to 31c are arranged collinearly with respect to one another and in such a way as to open in opposite directions. They form a contiguous tube system, in which the interspaces between the respective tubular air guide elements 31a and 31b or 31b and 31c are connected to one another by the cutouts 30 in the rest area 29. Cooling air A entering through the lower bulb openings 68 therefore flows first through the adjacently arranged set of air guide elements 31a to 31c up and on through the cutouts 30 in the rest area 29 and through the other set of air guide elements 31a to 31c as far as the upper bulb openings 68. The air emerges again as exhaust air B from the upper bulb openings 68. The heat sink 69 can be produced by fastening two heat sinks 28 to one another or by producing a heat sink 69 and subsequently applying separate tubular air guide elements 31a to 31c to that side of the rest area 29 which has not yet been equipped therewith.

In particular, the tubular air guide element 31c facing the base 2 can in turn act as a housing for a driver 71.

Since the printed circuit board 7 and the light emitting diodes 6 can now no longer be accommodated on the rest region 29, a flexible, strip-shaped printed circuit board 70 (alternatively a plurality of individual, even inflexible or rigid, LED/light source modules) is fastened with its rear side to an outer side of the (combined) tubular outer air guide element 31a, while the light emitting diodes 6 are arranged on its outwardly directed front side. The light emitting diodes 6 therefore form an outer ring, which is perpendicular to the longitudinal axis L.

This configuration has the advantage that the heat sink 69 has a very large cooling surface area which is easily accessible to the cooling air A through the bulb openings 68.

The inner construction of the lamp 66 can be shielded opaquely by the bulb 67, for example by means of a diffusely scattering, in particular milky-white, bulb 67.

The present invention is of course not restricted to the exemplary embodiments shown.

Thus, features of the individual embodiments can also be mixed, for example with respect to a number, shape and arrangement of the air passage openings.

In addition, the semiconductor light sources can also be arranged in a position other than on the rest region and can be fastened to the bulb, for example in the form of a ring or strip.

In general, at least one sealing element can be provided for fastening the bulb or another cover. The sealing element can be arranged, in particular pressed in, in particular on a front side of the rest region.

### LIST OF REFERENCE SYMBOLS

| | |
|---|---|
| 1 | LED incandescent lamp retrofit lamp |
| 2 | Base |
| 3 | Bulb |
| 3a | Central air passage opening |
| 4 | Heat sink |
| 5 | Driver housing |
| 6 | Semiconductor light source |
| 7 | Printed circuit board |
| 8 | Rest region |
| 9 | Lateral surface region |
| 9a | Outer side of heat sink |
| 9b | Inner side of heat sink |
| 10 | Air passage opening |
| 11 | Air passage opening |
| 11a | Air passage opening |
| 11b | Air passage opening |
| 12 | Air baffle |
| 13 | Interior |
| 15 | Sheet metal |
| 16 | Region in the form of an angle sector |
| 20 | LED incandescent lamp retrofit lamp |
| 21 | Heat sink |
| 22 | LED incandescent lamp retrofit lamp |
| 23 | Heat sink |
| 25 | LED incandescent lamp retrofit lamp |
| 26 | Heat sink |
| 27 | LED incandescent lamp retrofit lamp |
| 28 | Heat sink |
| 29 | Rest region |
| 30 | Cutout |
| 31 | Air guide element |
| 31a | Tubular air guide element |
| 31b | Tubular air guide element |
| 31c | Tubular air guide element |
| 32 | Light source space |
| 33 | LED incandescent lamp retrofit lamp |
| 34 | Heat sink |
| 34a | Heat sink |
| 35 | Lateral surface |
| 35a | Lateral surface |
| 35c | Inner side of heat sink |
| 36 | Rim |
| 37 | Rim |
| 38 | Air passage opening |
| 39 | Rest region |
| 40 | Cutout |
| 41 | Opening |
| 42 | LED incandescent lamp retrofit lamp |
| 43 | Cutout |
| 44 | Heat sink |
| 45 | LED incandescent lamp retrofit lamp |
| 46 | Heat sink |
| 47 | Upper side of step |
| 48 | Air passage opening |
| 49 | Cutout |
| 49a | Cutout |
| 50 | Side faces |
| 51 | LED lamp |
| 52 | Heat sink |
| 53 | Driver housing |
| 54 | Cooling channel |
| 55 | Open end |
| 56 | Opposite end |
| 57 | LED lamp |
| 58 | Air passage opening |
| 58a | Air passage opening |
| 59 | Heat sink |
| 59a | Heat sink |
| 59b | Lateral surface |
| 60 | Air baffle |
| 60a | Air baffle |
| 62 | LED incandescent lamp retrofit lamp |
| 63 | Heat sink |
| 64 | Lateral surface area |
| 65 | Cutout |
| 66 | LED incandescent lamp retrofit lamp |
| 67 | Bulb |
| 68 | Bulb opening |
| 69 | Heat sink |
| 70 | Printed circuit board |
| 71 | Driver |
| 72 | Air passage opening |
| 73 | Cutout |
| 74 | Tool |
| 76 | Heat sink |
| 77 | Hollow strut |
| 78 | Latching tab |
| 79 | Tool |
| 80 | Projection |
| 81 | Recess |
| R1 | Ring |
| R2 | Ring |
| R3 | Ring |
| R4 | Ring |
| R5 | Ring |
| L | Longitudinal axis |
| S1 | Column |
| S2 | Column |
| S3 | Column |
| S4 | Column |
| S5 | Column |
| S6 | Column |
| P1 | Arrow |
| A | Cooling air |
| B | Exhaust air |
| F | Compressive force |

1. A heat sink, wherein
the heat sink is constructed from at least one sheet-metal part and
comprises at least one flow structure
wherein the flow structure is configured to guide cooling air along an inner side of the heat sink, and
wherein the flow structure is configured to direct the cooling air at least partially along a longitudinal axis of the heat sink on the inner side of the heat sink.

2. The heat sink as claimed in claim 1, wherein the heat sink is configured as a heat sink for a retrofit lamp.

3. The heat sink as claimed in claim 1, wherein the heat sink comprises precisely one sheet-metal part.

4. The heat sink, as claimed in claim 1,
wherein the flow structure comprises a first group of air passage openings and
a second group of air passage openings,
wherein, in the case of a perpendicular position of the heat sink, the at least one air passage opening of the first group acts as an air inlet opening and the at least one air passage opening of the second group acts as an air outlet opening, and
wherein the air passage openings of the first group and the second group are arranged separately from one another along the longitudinal axis of the heat sink.

5. The heat sink as claimed in claim 4, wherein each group comprises a plurality of air passage openings which are arranged rotationally symmetrically with respect to the longitudinal axis of the heat sink.

6. The heat sink as claimed in claim 1, wherein at least one air passage opening is arranged in a rest region for at least one semiconductor light source of a semiconductor lamp.

7. The heat sink as claimed in claim 1, wherein the heat sink comprises a lateral surface which runs around the longitudinal axis of the heat sink and into which at least one ring of air passage openings is introduced, wherein in each case an air baffle is associated with at least some of the air passage openings.

8. The heat sink as claimed in claim 6, wherein the heat sink comprises at least two tubular air baffles which are arranged on the rest region for the at least one semiconductor light source of the semiconductor lamp, wherein the air baffles are arranged concentrically to the longitudinal axis of the heat sink, and wherein at least one of the air passage openings provided in the rest region is arranged on the rest region between the air baffles.

9. The heat sink as claimed in claim 8, wherein one of the tubular air baffles is configured as an outer wall of a driver housing.

10. The heat sink as claimed in claim 1, wherein the heat sink comprises, at at least one end, a shape which is, at least in a cross-sectional profile, curved.

11. The heat sink as claimed in claim 1, wherein the heat sink forms a plurality of vertically aligned air channels which are substantially separate from one another.

12. A semiconductor lamp comprising at least one heat sink, wherein the heat sink is constructed from at least one sheet-metal part and comprises at least one flow structure, wherein the flow structure is configured to guide cooling air along an inner side of the heat sink, and wherein the flow structure is configured to direct the cooling air at least partially along a longitudinal axis of the heat sink on the inner side of the heat sink.

13. The semiconductor lamp as claimed in claim 12, wherein the heat sink, together with another part of the semiconductor lamp, forms at least one of the air passage openings.

14. The semiconductor lamp as claimed in claim 12, wherein the semiconductor lamp is a retrofit lamp, which extends along a longitudinal axis and which
comprises, at its front end, at least one semiconductor source, which comprises an at least partially transparent cover arching over it, which
comprises, at its rear end, a base, and which
comprises, between the cover and the base, the heat sink.

15. The semiconductor lamp as claimed in claim 14, wherein the cover comprises at least one air passage opening.

16. The heat sink as claimed in claim 1, wherein the heat sink is configured as a heat sink for a semiconductor lamp.

17. The heat sink as claimed in claim 2, wherein the retrofit lamp is an incandescent retrofit lamp.

18. The heat sink as claimed in claim 10, wherein the shape is, at least in the cross-sectional profile, corrugated.

19. The semiconductor lamp as claimed in claim 12, wherein the semiconductor lamp is configured as a retrofit lamp.

20. The semiconductor lamp as claimed in claim 13, wherein the other part of the semiconductor lamp comprises a driver housing.

21. The semiconductor lamp as claimed in claim 14, wherein the retrofit lamp is an incandescent lamp retrofit lamp.
